(19) United States
(12) Patent Application Publication
(10) Pub. No.: US 2018/0039693 A1
(43) Pub. Date: Feb. 8, 2018

(54) LEARNED DATA FILTERING

(71) Applicant: Microsoft Technology Licensing, LLC, Redmond, WA (US)

(72) Inventors: Rishabh Singh, Kirkland, WA (US); Sumit Gulwani, Bellevue, WA (US); Xinyu Wang, Austin, TX (US)

(21) Appl. No.: 15/229,781

(22) Filed: Aug. 5, 2016

(51) Int. Cl. G06F 17/30

(52) U.S. Cl. CPC G06F 17/30696; G06F 17/30958; G06F 17/30675; G06F 17/30867

(57) ABSTRACT

Data items such as strings are filtered based on positive and negative examples provided by a user, where positive examples are to be included in a result set and negative examples are to be excluded. For each example, a filter generator determines a set of expressions that are satisfied by the example. Expressions corresponding to positive examples are intersected and expressions corresponding to negative examples are subtracted from the intersection to create a set of expressions that are consistent with every positive example and inconsistent with every negative example. The expressions may be represented as directed acyclic graphs that facilitate operations such as intersection and subtraction.

### BACKGROUND

Data filtering in spreadsheets is a common problem faced by end users. In data sets with large amounts of data, users often want to filter the data based on some criterion to work with a subset of data. Although certain spreadsheets may allow users to write regular expressions to filter data, many users lack the skill necessary to write such complex expressions.

### SUMMARY

This disclosure describes techniques for filtering sets of data based on examples obtained from a user. For example, a user may provide positive examples for inclusion in a result set and negative examples to be excluded from the result set. A filter synthesis engine analyzes each example, and for each example produces one or more regular expressions or other token sequences that are consistent with the example. The set of regular expressions corresponding to positive examples are then intersected, and the set of regular expressions corresponding to negative examples are subtracted from the intersection. This results in a set of token sequences where each token sequence of the set is consistent with every positive example and each token sequence of the set is inconsistent with every negative example.

A domain-specific language (DSL) is used to represent filter expressions in terms of token sequences. The DSL imposes structure on the space of possible expressions in order to enable efficient learning while keeping the language expressiveness to encode real-world data filtering tasks. Directed acyclic graphs (DAGs) are used to represent sets of token sequences.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a block diagram illustrating a system for filtering data items based on examples provided by a user.

FIG. 2 is a flow diagram illustrating an example method of filtering strings based on examples provide by a user.

FIGS. 3A and 3B are diagrams illustrating a sequence in which data items are filtered in accordance with examples provided by a user.

FIG. 4 is a flow diagram illustrating an example method of determining a filter expression based on example strings provided by a user.

FIG. 5 is a flow diagram illustrating an example method of determining a predicate-based filter expression.

FIG. 6 is a diagram illustrating a directed acyclic graph (DAG) such as may be used to represent token sequences.

FIG. 7 is a diagram illustrating the construction of a DAG from an example string.

FIGS. 8A-8D are diagrams illustrating DAGs corresponding to different predicates.

FIG. 9 is a flow diagram illustrating an example method of determining a filter expression using DAGs.

FIG. 10 is a flow diagram illustrating an example method of determining a DAG representing multiple token sequences, each of which is consistent with multiple positive example strings and each of which is inconsistent with multiple negative example strings.

FIGS. 11A and 11B are flow diagrams illustrating an example method for subtracting a second DAG from a first DAG.

FIGS. 12A-12C are diagrams illustrating operation of the method of FIGS. 11A and 11B.

FIG. 13 is a flow diagram illustrating an example method of creating a list of DAGs that represent disjunctive sets of token sequences.

FIG. 14 is a flow diagram illustrating an example method of merging DAGs of a list.

FIG. 15 is a flow diagram illustrating another example method of creating a list of DAGs that represent disjunctive sets of token sequences.

FIG. 16 is a flow diagram illustrating an example method of ranking token sequences.

FIG. 17 is a block diagram illustrating high-level components of a computing device that may be used to implement the techniques described herein.

### DETAILED DESCRIPTION

### Overview

A spreadsheet presents an example of a usage scenario in which a long list of data may be displayed to a user, and in which the user may wish to filter the data to show only those data items having certain characteristics. The techniques described herein allow a user to specify positive and negative examples of data items, which are then used to create a filter expression. The filter expression is applied to the entire list of data items to create a result set that includes the positive examples and similar data items, while excluding negative examples and similar data items. The user may incrementally provide additional positive and/or negative examples, which are used to refine the filter expression so that it produces a result set that more closely corresponds to the user's expectations.

More specifically, a filter engine may receive an identification of positive character string examples and an identification of negative character string examples. For each positive example, the filter engine determines one or more token sequences, wherein each such token sequence defines a respective character pattern that is consistent with the positive example.

The token sequences may comprise regular expressions, for example, where each token represents a specific character, a general type of character, or a string comprising characters of a particular type. A token sequence is said to be consistent with a character string if the string satisfies the pattern specified by the token sequence. A token sequence is said to be inconsistent with a character string if the string does not satisfy the pattern specified by the token sequence. A string is said to be consistent with a token sequence if the string satisfies the pattern specified by the token sequence.

The filter engine intersects the sets of token sequences corresponding to the positive string examples, which is equivalent to removing any token sequence (from the set of all possible token sequences) that is not consistent with any one of the positive string examples. This results in a set of token sequences, where each token sequence in the set is consistent with all of the positive string examples.

For each negative example, the filter engine also determines one or more token sequences, wherein each such token sequence defines a respective character pattern that is consistent with the negative example. Each such token sequence is then removed from the set of token sequences. Each token sequence of the resulting set of token sequences is consistent with all of the positive string examples, and each sequence of the resulting set of token sequences is inconsistent with all of the negative string examples.

The token sequences of the set are then ranked in accordance with their generality, with more general token sequences being ranked more highly than less general token sequences. One or more of the more highly ranked token sequences are then selected and applied to the entire data list to produce a result set.

The techniques described above may be performed iteratively. In this case, a user may provide a few positive and/or negative examples and the filter engine may present a result list. The user may indicate additional items of the result list to be excluded and/or may indicate excluded items that should have been included. The filter engine then updates its calculations and presents a new result set.

A set of token sequences may be represented as a directed acyclic graph (DAG) having nodes, some of which may be start nodes, some of which may be end nodes, and some of which may be neither. A DAG has directed edges between certain nodes. Each DAG edge corresponds to a set of one or more tokens. A path from a start node to an end node corresponds to a token sequence, wherein the edges traversed by the path correspond to the tokens of the sequence.

Representing sets of token strings as DAGs facilitates certain types of computations. For example, intersecting two sets of token sequences can be accomplished by an intersection operation [symbol] on respectively corresponding DAGs. A second set of token sequences can be subtracted from a first set of token sequences using a subtraction operation ⊖. Example implementations of the [symbol] and ⊖ operations will be described below.

### General Operation

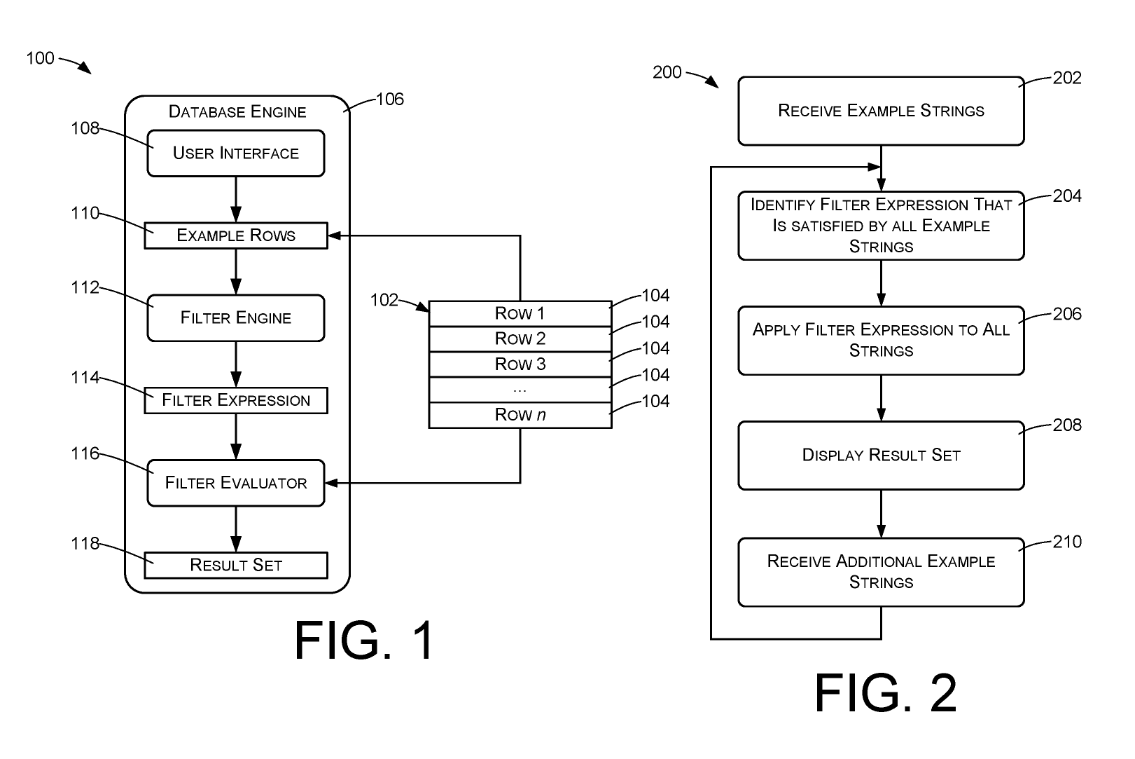

FIG. 1 shows an example system 100 having a database 102, which comprises a list or set of multiple data items 104. In some situations, such as within a spreadsheet, the data items 104 may be arranged as rows of a column, and the database 102 may also have additional columns.

Each data item comprises an alphanumeric string or other data that can be represented as an alphanumeric string. An alphanumeric string may contain letters of the alphabet, numerical digits, etc.

The database 102 may be part of or may be associated with a database engine 106. The database engine 106 may be a spreadsheet application, as one example. As another example, the database engine may comprise a relational database or other database application. The described techniques may also be used in other situations or applications in which a user might desire to filter lists of data based on user-provided examples. For example, such filtering might be used within, word processing applications or documents, customer relationship management systems, email applications and systems, etc.

A user may at times wish to filter items of the database 102 in accordance with certain criteria, so that only selected rows whose data has certain characteristics are visible. By filtering based on the criteria, a subset of the items 104 are selected and displayed by the database engine. When showing the subset of items, associated data may also be shown. For each row of a spreadsheet, for example, multiple data columns may be shown. In a relational system, as another example, other data associated relationally with the selected data items may also be shown.

The database engine 106 has a user interface component 108 that is responsible for interacting with the user. The user interface component 108 may be configured to guide a user through a process of defining a data filter based on a selection by the user of certain items 104 of the database 102. In particular, the user interface component 108 may allow the user to select multiple example rows 110, wherein each example row 110 may be a positive example or a negative example. A positive example is a row that is to be included in filter results. A negative example is a row that is to be excluded from filter results.

The database engine 106 has a filter engine 112 that is responsive to the positive and negative example rows 110 to create a filter expression 114. In the described embodiments, a filter expression is a sequence of tokens that defines a character pattern.

The database engine 106 has a filter evaluator 116 that evaluates the filter expression 114 against the database 102 to select one or more rows 118 of the database 102 that are to be included in a result set. The selected rows are those rows having data that match the filter expression 114. The selected rows 118, as well as other data associated with the selected rows 118, may then be displayed to the user or used for other purposes.

FIG. 2 shows an example method 200 of filtering database items. An action 202 comprises receiving one or more example input strings. An example input string may comprise a positive example that is intended by the user to be included in filtered results. Alternatively, an example input string may comprise a negative example that is intended by the user to be excluded from filtered results.

The example input strings may be provided collectively or incrementally. The action 202 may comprise displaying all or a portion of the data items 104 and accepting a selection by a user of any items that should be included in the result set 118. The action 202 may also comprise accepting a selection by the user of any items that should not be included in the filtered view.

An action 204 comprises creating and/or identifying a filter expression that is satisfied by all of the example strings. Specifically, a filter expression is identified such that when the filter expression is applied to all of the input strings, all of the positive examples are included and all of the negative examples are excluded. Techniques for identifying such a filter expression will be described below.

An action 206 comprises evaluating the filter expression against the items of the database 102 to identify all items that satisfy the filter expression. Specifically, for each item 104, the action 206 comprises determining whether the value of the item satisfies the created filter expression.

An action 208 comprises displaying or listing the data items that match the filter expression.

An action 210 may also be performed, comprising receiving one or more additional example strings. For example, the user interface 108 may be configured to display the selected data items and to allow the user to indicate any of the displayed items that should additionally be excluded. The action 204 is thereupon repeated to update the filter expression, the filter expression is evaluated anew, and the resulting data items 104 are displayed. The method 200 may be repeated in this mariner until the user is satisfied with the results of the filtering.

### Filtering Example

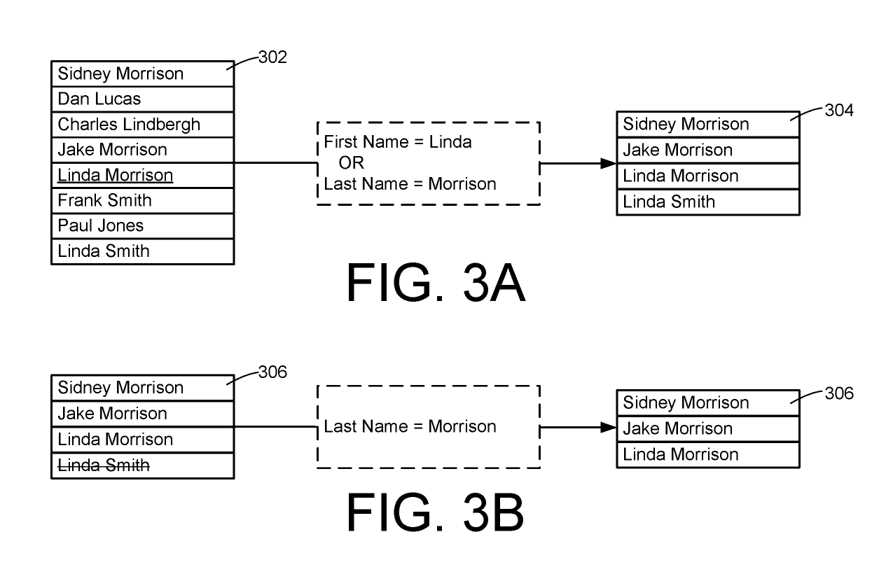

FIGS. 3A and 3B illustrate user interactions and resulting filtering in a very simple example scenario. Referring to FIG. 3A, a database 302 may have rows with first and last names of people. A user may select “Linda Morrison” as an example of a name that is to be included in displayed results (where such a positive selection is indicated by underlining) In response, the filter engine 112 may create a filter expression that matches all names where either the first name is “Linda” or the second name is “Morrison”. This results in a filtered view 304, containing all entries where the first name is “Linda” or the second name is “Morrison”. Techniques for creating such a filter expression will be explained below.

Referring now to FIG. 3B, upon examining the view 304 the user realizes that the name “Linda Smith” has been undesirably included in the filtered results, and the user deselects that name (where such negative selection is indicated in this example by strikeout). In response, the filter engine 112 creates a new filter expression or modifies the existing filter expression so that the filter expression matches only those database rows where the last name is “Morrison”. This yields the desired result view 306.

Although not shown, a user might subsequently add positive examples. For example, the user might select the name “Jim Morris” as a positive example. In response, the filter engine 112 might modify the regular expression to match any row where the last name starts with “Morris”.

### Filter Expressions

The filter expression 114 may be specified using a suitable language and syntax. In the described embodiments, the filter expression 114 is specified using a domain specific language (DSL) that is designed to impose a structure on the space of possible expressions in order to enable efficient learning while keeping the language expressiveness to encode real-world data filtering tasks.

In the described implementation, a filter f is defined as follows:

| | | |
|---|---|---|
| Filter f | := | Filter(p,L) |
| Predicate p | := | StartsWith(v,r) |
| | \| | EndsWith(v,r) |
| | \| | Matches(v,r) |
| | \| | Contains(v,r) |
| DisjExpr r | := | Disjunct(ts,r) \|ts |
| TokenSeq ts | := | Seq(T,ts) \|T |

where L is a list of input strings that are to be filtered, v is an input string of L, T is a token, and r is a disjunctive expression that specifies one or more alternatives. A token sequence is is a sequence of tokens as will be described below.

The vertical bar symbol is used to indicate disjunction. Accordingly, a predicate p may comprise any of the predicates “Startswith”, “EndsWith”, “Matches”, or “Contains”.

The nomenclature Seq(a, b, . . . , n) indicates a sequence of elements a through n. A sequence of tokens is is defined recursively and may therefore include any sequence of any number of individual tokens.

The disjunctive expression r is also defined recursively such that r may include one or multiple token sequences. Each predicate p therefore specifies one or more disjunctive token sequences.

At points in the following discussion, the notation [s:l] is used to denote a list of strings with s being the first string in the list and l being all the remaining list. The notation s[i, j] denotes the substring of a string s starting at position i (inclusive) and ending at position j (exclusive). The notation denotes the length of the string s.

Tokens of the DSL are specified such that each token matches a character, a type of character, or a sequence of characters. The tokens can be concatenated to specify character sequences in various ways.

In the described embodiments, the tokens are selected from a set that contains two types of tokens: constant tokens and general tokens. A constant token matches only one particular character or string. Thus, the constant token <A> matches only the character “A”, while the general token <Alpha> matches any sequence of alphabet letters. The general token <Num> matches any sequence of digits.

The semantics of token matching are defined unambiguously by the construction of the token. Specifically, the tokens used in the DSL comprise constant tokens for (a) each uppercase and lowercase letter, (b) each digit between 0 and 9, and (c) special characters such as the hyphen, dot, semicolon, colon, comma, left/right parenthesis/bracket, forward slash, backward slash, whit space, etc. The tokens used in the DSL include general tokens for (a) any digit, (b) any alphabet letter, (c) any sequence of any digits, (e) any sequence of any alphabet letters, (f) any sequence of any uppercase letters, (g) any sequence of any lowercase letters, etc. The token set may also include higher-level general tokens, such as date, phone number, etc., to capture patterns that are often used.

The semantics of matching a token sequence is to a string s include three rules: (a) an empty string is not matched by any token sequence, (b) if ts is simply a token T, then is matches a string s if T matches s, and (c) if ts=Seq(T, ts′) consists of more than one token, look first for the longest prefix s[0, i] of s that is matched by the first token T in ts, and then check recursively whether the remaining token sequence ts′ matches the remaining substring s[i, |s|]. For example, ts=Seq (<Alpha>, <Num>) matches string “ABC123”, whereas it does not match string “123ABC” or “ABC123DEF”. Note that the number of tokens in a token sequence is unbounded.

A disjunctive expression r is defined as a disjunction of token sequences: if at least one token sequence in r matches a string s, then r is defined to match s. Adding the disjunction expression enables the DSL to construct expressions that can match “incompatible” strings and simulate the effects of the Kleene star, both of which increase the expressiveness of the DSL. Certain embodiments may be implemented without the use of disjunctive expressions.

Predicates generalize the semantics of disjunctive expressions, allowing a disjunctive expression r to match a prefix (“StartsWith”), a suffix (“EndsWith”), or a substring (“Contains”) of the string s, in addition to matching the whole string (“Matches”).

A filter expression Filter(p, L) maps an input list L of m strings to an output list of n strings where n less than or equal to m. Stated alternatively, the filter expression filters out strings in L for which p does not hold true.

For simplicity, it will be assumed in subsequent descriptions that tokens <l>, <a>, <d>, and <n> are used in token sequences, corresponding respectively to an alphabet letter, a sequence of alphabet letters, a digit, and a sequence of digits. As an example of usage, assume an input string “RJ1”. Filter expressions that are satisfied by the input string “RJ1” include StartsWith(v, <a>), StartsWith(v, <l>), StartsWith(v, Seq(<l>, <l>)), etc., as well as filter expressions using other predicates.

Note that some implementations may use different ones of the DSL tokens and predicates described above or may use different types of DSL tokens and predicates. The DSL described above is designed to express a variety of filtering tasks where the database contains a finite number of strings and each string is of finite length. The described DSL is able to do this because the token set in the DSL consists of a constant token for each possible character and the DSL supports disjunctive expressions over token sequences of arbitrary length.

Creating Filter Expressions from Examples

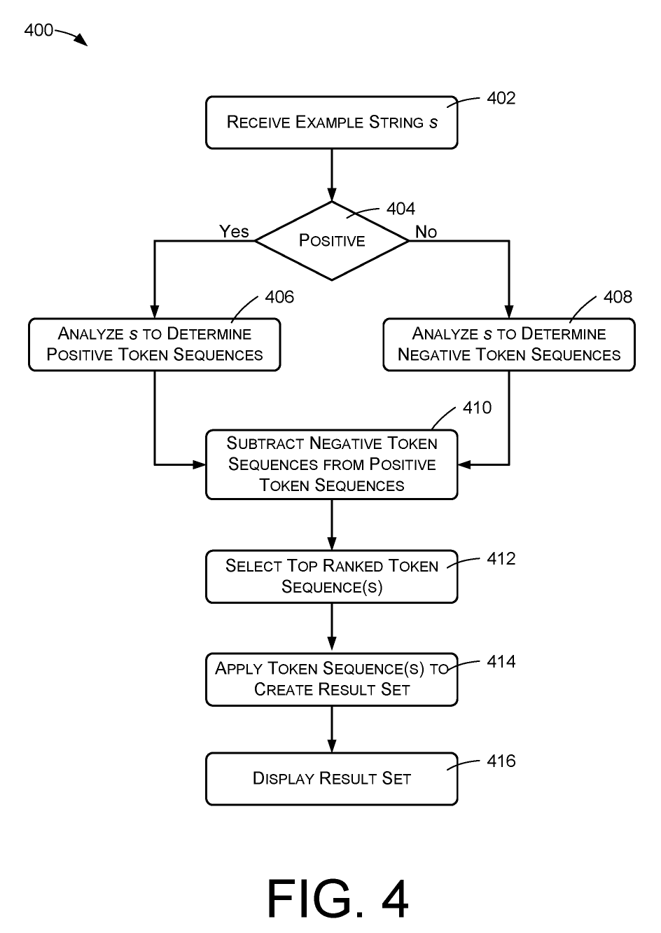

FIG. 4 illustrates an example method 400 that may be used in certain implementations to produce a set of one or more token sequences in accordance with positive and negative examples given by a user.

An action 402 comprises receiving identification of one or more example input strings s from a database or other list of strings. An example input string may comprise a positive example that is intended by the user to be included in a result set. Alternatively, an example input string may comprise a negative example that is intended by the user to be excluded from the result set. The example input strings may be provided collectively or incrementally.

If the example input string is a positive example, as determined by the action 404, an action 406 is performed of analyzing the input string to calculate or otherwise determine one or more positive token sequences that are consistent with the input string. If the example input string is a negative example, as determined by the action 404, an action 408 is performed of analyzing the input string to calculate or otherwise determine one or more negative token sequences that are consistent with the input string. Because the method 400 may be iterated over multiple example input strings, this may result in positive token sequences corresponding respectively to multiple positive example input strings and negative token sequences corresponding respectively to multiple negative example input strings.

In certain embodiments described herein, the actions 406 and 408 are implemented so that they generate token sequences for one of the predicates described above. For example, the method 400 may be executed to generate token sequences for any one of the predicates “StartsWith”, “EndsWith”, “Matches”, or “Contains”. The resulting token sequences selected in the action 412 similarly correspond to the same predicate.

An action 410 comprises subtracting or removing the negative token sequences from the positive token sequences to produce a set of token sequences that includes all of the positive token sequences that are not within the negative token sequences. Each token sequence of this set is consistent with all of the positive example strings and inconsistent with all of the negative example strings.

An action 412 comprises selecting one or more top-ranked token sequences from the set of token sequences. A technique for ranking token sequences will be described in more detail below.

An action 414 comprises disjunctively applying the selected token sequences to the input data to produce a result set. An action 416 comprises displaying the result set to a user.

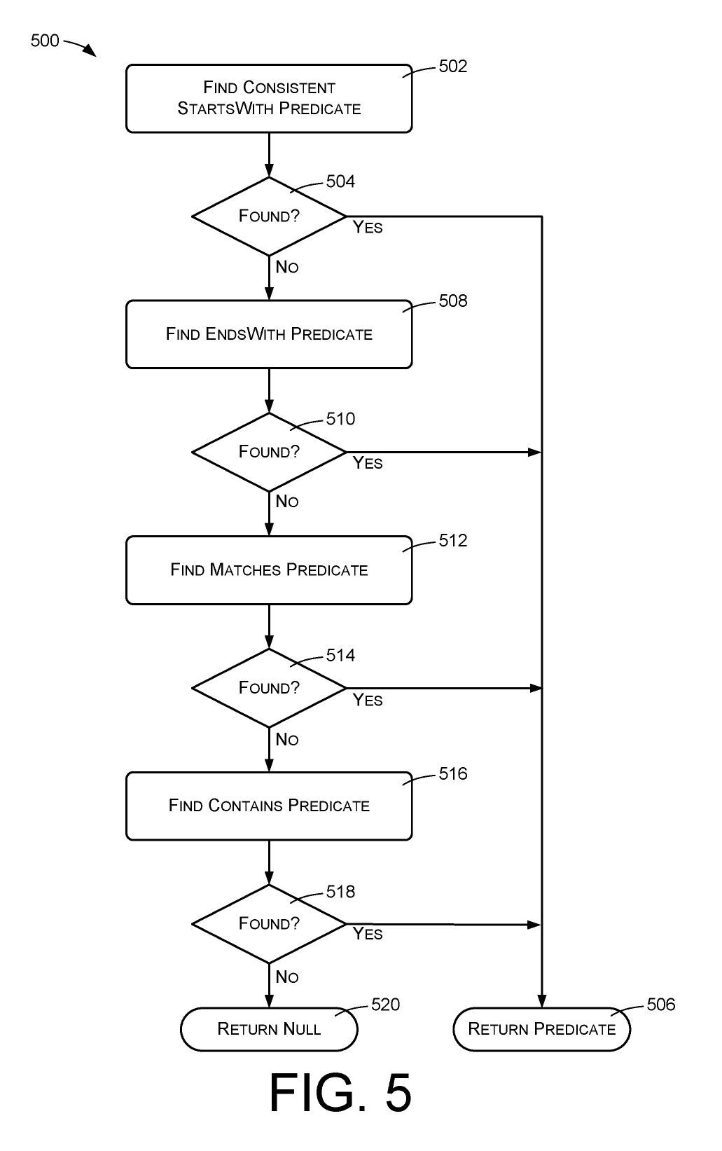

FIG. 5 shows an example method 500 of identifying a filter expression. Although FIG. 5 shows certain techniques at a high level, further details will subsequently be described.

The method 500 attempts to find a filter expression that specifies one of the four predicate types, where the “StartsWith” predicate is given the highest priority, the “EndsWith” predicate is given the next lowest priority, the “Matches” predicate is given a priority below that of “EndsWith”, and the “Contains” predicate is given the lowest priority.

An action 502 comprises attempting to find a “StartsWith” predicate that is consistent with all of the example strings. A predicate is considered to be consistent with the example strings if its application to the data set results in the inclusion of all positive example strings and the exclusion of all negative example strings. The action 502 may be performed in accordance with the method 400, for example, where the actions 406 and 408 are configured to generate token sequences in accordance with the “StartsWith” predicate.

If such a “StartsWith” predicate is found, as shown at 504, an action 506 is performed of returning the “StartsWith” predicate as a filter expression.

If a consistent “StartsWith” predicate is not found, an action 508 is performed of attempting to find an “EndsWith” predicate that is consistent with all of the example strings. The action 508 may be performed in accordance with the method 400, for example, where the actions 406 and 408 are configured to generate token sequences in accordance with the “EndsWith” predicate.

If such an “EndsWith” predicate is found, as shown at 510, the action 506 is performed of returning the “EndsWith” predicate as a filter expression.

If a consistent “EndsWith” predicate is not found, an action 512 is performed of attempting to find a “Matches” predicate that is consistent with all of the example strings. The action 512 may be performed in accordance with the method 400, for example, where the actions 406 and 408 are configured to generate token sequences in accordance with the “Matches” predicate.

If such a “Matches” predicate is found, as shown at 514, the action 506 is performed of returning the “Matches” predicate as a filter expression.

If a consistent “Matches” predicate is not found, an action 516 is performed of attempting to find a “Contains” predicate that is consistent with all of the example strings. The action 516 may be performed in accordance with the method 400, for example, where the actions 406 and 408 are configured to generate token sequences in accordance with the “Contains” predicate.

If such a “Contains” predicate is found, as shown at 518, the action 506 is performed of returning the Matches predicate as a filter expression. If a “Contains” predicate is not found, an action 520 is performed of returning a null value, indicating that no consistent expressions were found.

### Directed Acyclic Graph (DAG) Data Structure

In described embodiments, a directed acyclic graph (DAG) data structure is used to succinctly represent a large set of token sequences. A list of DAGs is used to represent a set of disjunctive expressions. In the following discussion, a DAG is represented by the symbol [symbol] and a list of DAGs is represented by the symbol [symbol] . Generally, symbols corresponding to lists are shown with the tilde accent ˜ in the following discussion. An individual instance of a list is represented by the same symbol, without the tilde accent.

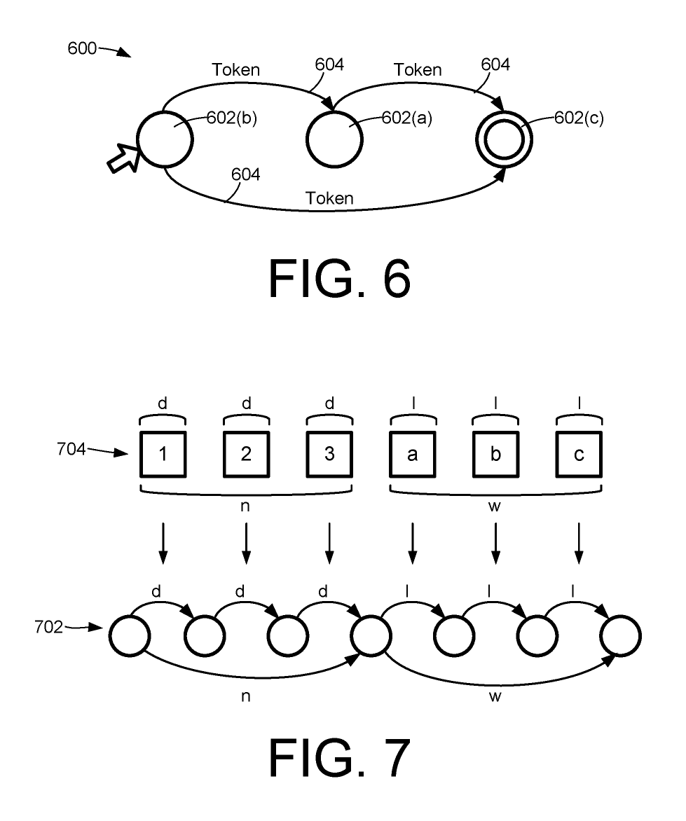

FIG. 6 logically illustrates an example DAG 600. The DAG 600 comprises any number of nodes 602, which may include one or more start nodes 602(a), one or more intermediate nodes 602(b), and one or more end nodes 602(c). In FIG. 6 and following figures, nodes are generically represented as circles, a start node is represented as a circle with an attached arrow, and an end node is represented as a double-circle, all as shown in FIG. 6.

The DAG 600 may have multiple edges 604 between nodes 602. Each edge represents a token.

FIG. 7 shows an example of how a DAG 702 may be used to represent tokens and token sequences that correspond to a given string 704. In this example, the string 704 comprises “123abc”. Each digit can be represented by the token <d> and the leading sequence of digits can be represented by the token <n>. Each letter can be represented by the token <l> and the trailing sequence of letters can be represented by the token <w>. In addition to these general tokens, each element of the string 704 may also be represented as a constant token, although for simplicity this is not shown in FIG. 7.

The DAG 702 shows edges and associated tokens corresponding to each of the tokens. Various different token sequences may be constructed by moving through the edges of the graph, such as the sequence (<d>,<d>,<d>,<l>,<l>,<l>), the sequence (<n>,<l>,<l>,<l>), the sequence (<d>,<d>,<d>,<w>), and subsequences of these sequences. Sequences constructed in this manner correspond to token sequences that are satisfied by the string 704.

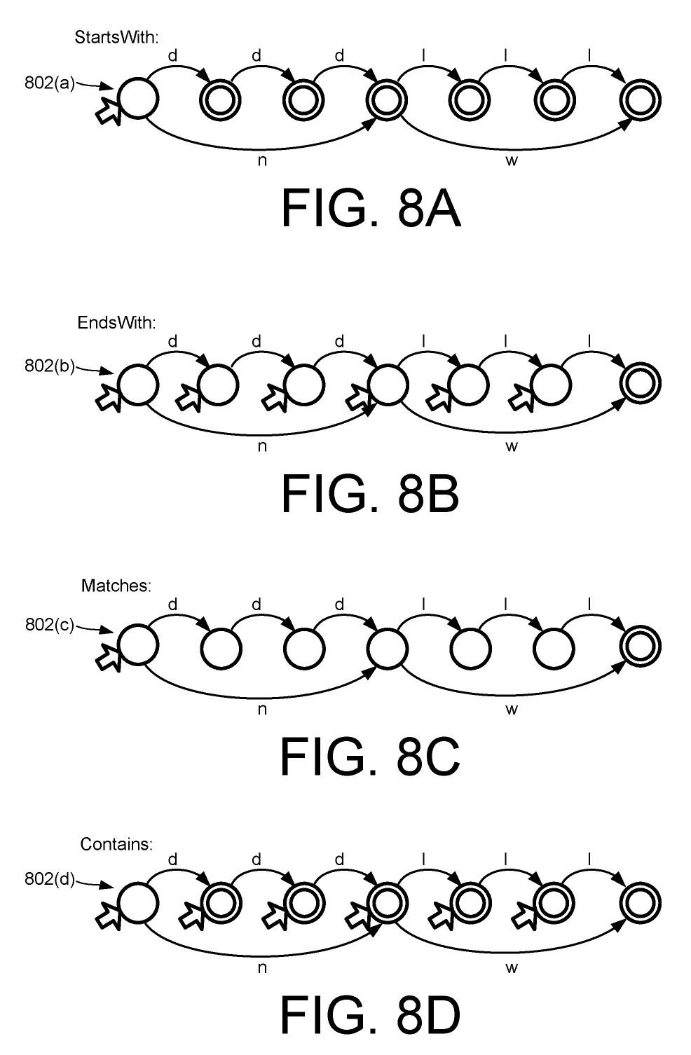

FIGS. 8A-8D illustrate how DAGs may be used to represent sets of token sequences corresponding to different predicates. FIG. 8A illustrates a DAG 802(a) where the first node is defined to be a start node, so that the DAG 802(a) corresponds to the StartsWith predicate. FIG. 8B illustrates a DAG 802(b) where the last node is defined to be an end node, so that the DAG 802(b) corresponds to the EndsWith predicate. FIG. 8C illustrates a DAG 802(c) where the first node is defined to be a start node and the last node is defined to be an end node, so that the DAG 802(c) corresponds to the Matches predicate. FIG. 8D illustrates a DAG 802(d) where all except the last node are defined to be start nodes and all except the first node are defined to be end nodes, so that the DAG 802(d) corresponds to the Contains predicate.

In any of the DAGs 802(a)-802(d), any edge sequence that extends from a start node to an end node is considered a valid token sequence for the corresponding predicate.

A DAG data structure [symbol] (\tilde{η}, \tilde{η}^{s}\tilde{η}^{e}, \tilde{ξ}, \tilde{W}) is used to represent any of the structures shown by FIGS. 8A-8D, where \tilde{η} is a set of nodes containing a set of start nodes \tilde{η}^{s} and a set of end nodes \tilde{η}^{e}, \tilde{ξ} is a set of edges over nodes in \tilde{η} that induces the DAG, and \tilde{W} maps each edge to a set of tokens \tilde{t}.

The set of token sequences represented by a DAG [symbol] (\tilde{η}, \tilde{η}^{s}, \tilde{η}^{e}, \tilde{ξ}, \tilde{W}) includes those token sequences that can be obtained by concatenating tokens along any path (one token for each edge) from a start node to an end node. A list of DAGs [symbol] represents a set of disjunctive expressions that are disjunctions of the token sequences represented by the DAGs in the list.

In order to construct a DAG for a single string s, a set of nodes \tilde{η} is generated as \tilde{η}={0, . . . , |s|}, where |s| is the length of the string. When generating a DAG for a StartsWith predicate, start nodes and end nodes are assigned as \tilde{η}^{s}={0} and \tilde{η}^{e}={1, . . . , |s|}, respectively. When generating a DAG for an EndsWith predicate, start nodes and end nodes are assigned as \tilde{η}^{s}={0, . . . , |s|−1}} and \tilde{η}^{e}={|s|}, respectively. When generating a DAG for a Matches predicate, start nodes and end nodes are assigned as \tilde{η}^{s}={0} and \tilde{η}^{e}={|s|}, respectively. When generating a DAG for a Contains predicate, start nodes and end nodes are assigned as \tilde{η}^{s}={0, . . . , |s|−1}} and \tilde{η}^{e}={1, . . . , |s|}, respectively.

An edge (i,j) is then added between each pair of nodes i and j such that 0≦i≦j≦|s|. Each edge (i,j) is labeled with a set of tokens \tilde{W}(i,j)), each of which matches the substring s[i,j] but not any substring s[i, k], where k>j.

Determining Filter Expressions from DAGS

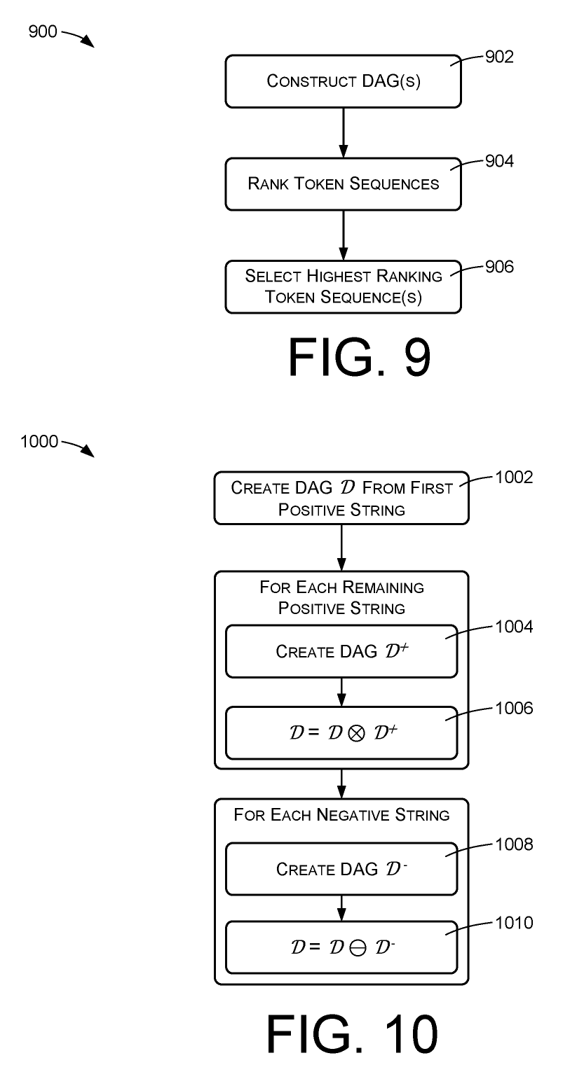

FIG. 9 illustrates an example method 900 of determining a filter expression for a particular predicate. The method 900 is an example implementation of one of the actions 502, 508, 512, and 516.

An action 902 comprises constructing a DAG [symbol] or a list of DAGs [symbol] , wherein the DAG [symbol] or each DAG [symbol] of the list [symbol] represents one or more token sequences that are consistent with every one of one or more positive example strings and inconsistent with every one of one or more negative example strings. In the case of a list of DAGs, the multiple DAGs of the list represent disjunctive specifications of token sequences that form the basis for selecting disjunctive token sequences to be indicated by the predicate.

An action 904 comprises ranking the token sequences represented by the DAG [symbol] or list of DAGs [symbol] . An action 906 comprises selecting the highest ranking token sequence or sequences. In the case of a list of DAGs, the action 906 may comprise selecting the highest ranked token sequence from each DAG, and specifying the collective selected token sequences as a disjunctive expression r for use in conjunction with the predicate.

FIG. 10 illustrates an example method 1000 of constructing a single DAG that is for a set of multiple example strings, wherein the example strings includes positive examples \tilde{S}⁺ and negative examples \tilde{S}⁻. The method 1000 is an example implementation of the action 902 of FIG. 9.

An action 1002 comprises creating a DAG [symbol] for the first positive example S⁺[0]. A DAG for a given predicate that is consistent with a single string may be constructed as already described.

The DAG [symbol] represents all token sequences that are consistent with the first positive example S⁺[0], and is created as described above. Actions 1004 and 1006 are then performed for every remaining positive example string S⁺.

The action 1004 comprises creating a DAG [symbol] ⁺ from the positive example string S⁺. The action 1006 comprises intersecting the newly created DAG [symbol] ⁺ with the DAG [symbol] in accordance with the operator [symbol] . In this context, intersecting a first DAG and a second DAG means intersecting the set of token sequences represented by the first DAG with the set of token sequences represented by the second DAG. The intersection operation represented by the [symbol] operator will be described in more detail below.

The resulting intersected DAG [symbol] represents the set of all token sequences for a given predicate that are consistent with the list of positive strings \tilde{S}⁺.

Actions 1008 and 1010 are then performed for each negative example S⁻. The action 1008 comprises learning a DAG [symbol] ⁻ from the negative example string S⁻, such that the DAG D⁻ represents token sequences that are consistent with the negative example string S⁻. A DAG for a given predicate that is consistent with a single string may be constructed as already described.

The action 1010 comprises subtracting the token sequences represented by [symbol] ⁻ from those in [symbol] , as indicated by the operator ⊖. The subtraction operation represented by the ⊖ operator will be described in more detail below.

The resulting DAG [symbol] represents the set of all token sequences for the given predicate that are consistent with the list of positive example strings \tilde{S}⁺ and inconsistent the list of negative strings and \tilde{S}⁻.

### DAG Intersection Operator

The [symbol] operator constructs a product graph of two DAGs [symbol] ₁ and [symbol] ₂, while at the same time intersecting the tokens on the edges of the resulting DAG [symbol] ₃. The nodes \tilde{η}₃ of [symbol] ₃ comprise the cross-product of the nodes \tilde{η}₁ of [symbol] ₁ and the nodes \tilde{η}₂ of [symbol] ₂. The start nodes \tilde{η}₃^{s} of [symbol] ₃ comprise the start nodes \tilde{η}₁^{s} of [symbol] ₁ and the start nodes \tilde{η}₂^{s} of [symbol] ₂. The end nodes \tilde{η}₃^{e} of [symbol] ₃ comprise the end nodes \tilde{η}₁^{e} of [symbol] ₁ and the end nodes \tilde{η}₂^{e} of [symbol] ₂. The edges ξ₃ of [symbol] ₃ comprise the edges \tilde{ξ}₁ of [symbol] ₁ and the edges \tilde{ξ}₂ of [symbol] ₂. The tokens W₃ on any edge ξ₃=<(η₁, η₃), (η₂, η₄)> of [symbol] ₃ comprise the intersection of the tokens W₁ and W₂ on the respectively corresponding edges ξ₁=<(η₁, η₂)> of D₁ and ξ₂=(η₃, η₄)> of [symbol] ₂.

### DAG Subtraction Operator

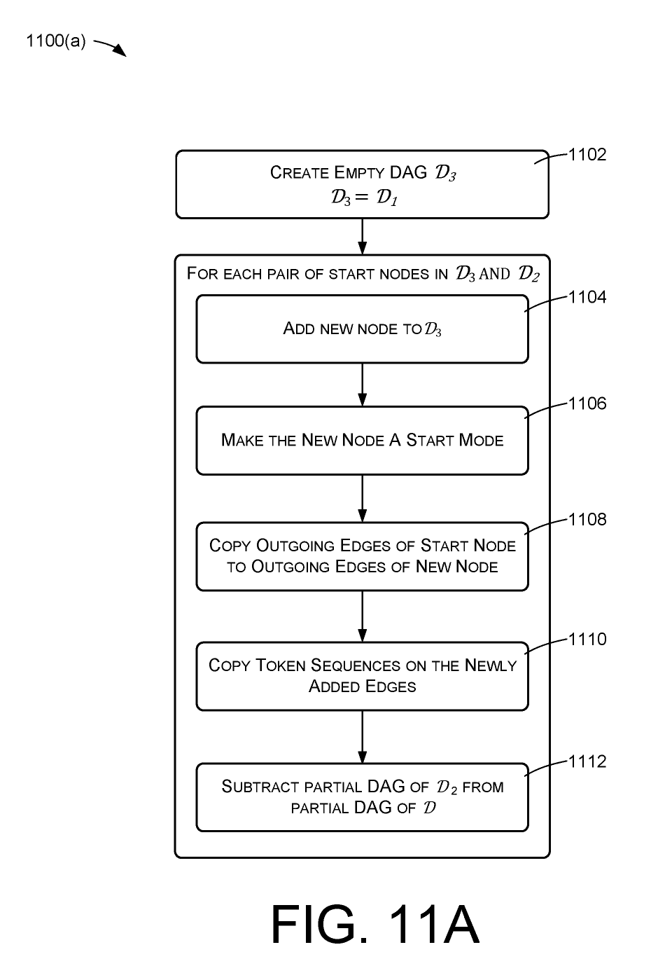

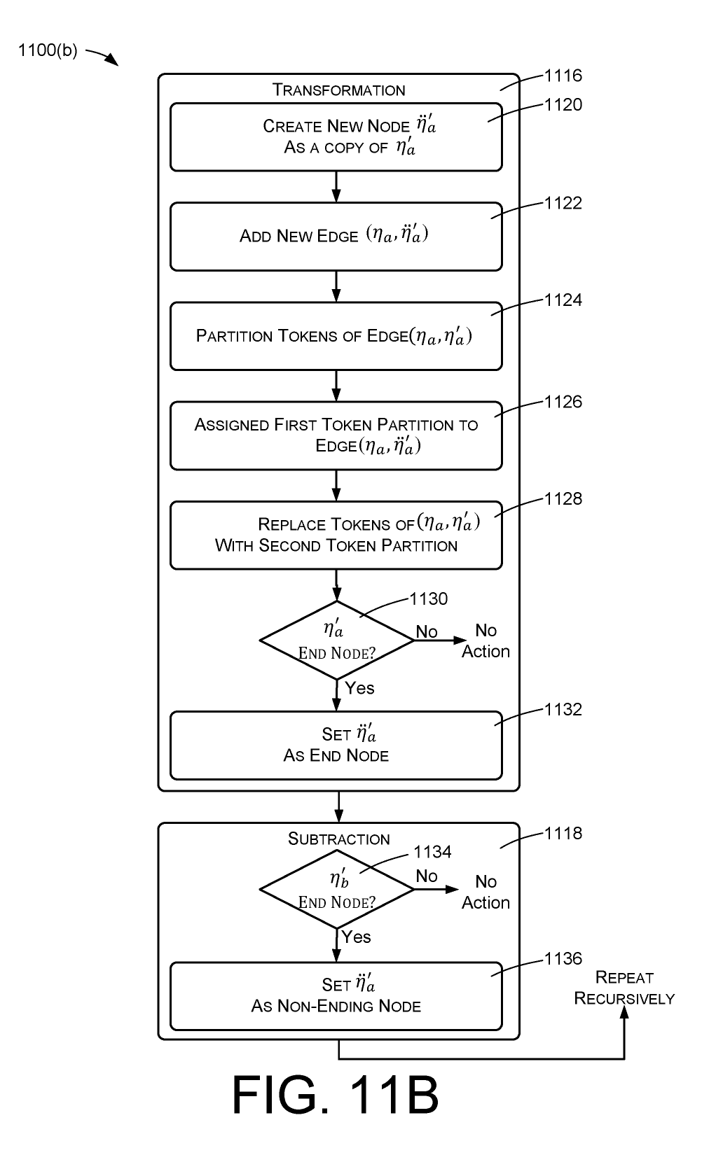

FIGS. 11A and 11B illustrate an example method 1100 of implementing the ⊖ operator, which may be referred to herein as a subtraction operator. Generally, the method 1100 is performed to implement [symbol] ₁ ⊖ [symbol] ₂ by removing token sequences of each partial DAG of [symbol] ₂ from the token sequences of each partial DAG in [symbol] ₁. A partial DAG is a subgraph of the original DAG with only one start node.

Note that when removing a token sequence of a partial DAG of [symbol] ₂ from a partial DAG of [symbol] ₁, it might be possible to mistakenly remove tokens on other paths in [symbol] ₁, since there are multiple start nodes in [symbol] ₁ and edges are shared by multiple paths. The method 1100 avoids this by making copies of nodes and edges, but only when necessary (in a lazy manner).

Referring first to FIG. 11A, which illustrates a sub-method 1100(a) of the method 1100, an action 1102 comprises creating a new DAG [symbol] ₃ and copying [symbol] ₁ to it, so that [symbol] ₃ is initially a copy of [symbol] ₁. Actions 1104, 1106, 1108, 1110, 1112, and 1106 are then performed for each pair of start nodes η₃^{s} and η₂^{s} in [symbol] ₃ and [symbol] ₂, respectively.

The action 1104 comprises (a) adding a new node \ddot{η}₃^{s} to [symbol] ₃. The action 1106 comprises making the new node \ddot{η}₃^{s} a start node in place of η₃^{s} without removing η₃^{s} from the non-start nodes of [symbol] ₃. An action 1108 comprises copying any outgoing edges of η₃^{s} to outgoing edges of \ddot{η}₃^{s}. An action 1110 comprises copying tokens from the outgoing edges η₃^{s} to the tokens on corresponding edges of \ddot{η}₃^{s}. An action 1112 then comprises subtracting the partial DAG in [symbol] ₂ rooted at η₃^{s} from the partial DAG in [symbol] ₃ rooted at \ddot{η}₃^{s}.

FIG. 11B illustrates a sub-method method 1100(b) that may be used to implement the action 1112 of FIG. 11A. The sub-method 1100(b) is performed with respect to a first partial DAG of [symbol] ₐ that is rooted at node ηₐ and a second partial DAG of [symbol] _{b} that is rooted at node η_{b}. In particular, the sub-method 1100(b) subtracts the second partial DAG of [symbol] _{b} from the first partial DAG of [symbol] ₐ.

Given the two root nodes ηₐ and η_{b}, a set of actions 1114 iterates over each pair of outgoing edges of ηₐ and η_{b}. During each iteration, the outgoing edges comprise a first edge (ηₐ, η′ₐ) and second edge (η_{b}, η′_{b}), where η′ₐ is a node that is connected by an outgoing edge from ηₐ and η′_{b} is a node that is connected by an outgoing edge from η_{b}. Each of the first and second edges has a corresponding set of assigned tokens.

Each iteration comprises a DAG transformation 1116 and a DAG subtraction 1118. The DAG transformation transforms [symbol] ₐ into [symbol] ′ₐ.

Within the DAG transformation 1116, an action 1120 comprises adding a new node \ddot{η}′ₐ to [symbol] ₐ as a copy of η′ₐ, including copying the outgoing edges of η′ₐ and the token labels of those edges to [symbol] ₐ. An action 1122 comprises adding an edge (ηₐ, \ddot{η}′ₐ) to [symbol] ₐ that extends from node ηₐ to the new node \ddot{η}′ₐ.

An action 1124 is then performed of partitioning the original token set of the edge (ηₐ, η′ₐ) into first and second token sets. The first token set comprises the intersection of the tokens of the first and second edges (ηₐ, η′ₐ) and (η_{b}, η′_{b}). The second token set comprises any tokens of the edge (ηₐ, η′ₐ) that are not also in the tokens of the edge (η_{b}, η′_{b}). An action 1126 comprises assigning the first token set to the edge (ηₐ, \ddot{η}′ₐ). An action 1128 comprises replacing existing tokens of the edge (ηₐ, η′ₐ) with the second set of tokens.

An action 1130 comprises determining whether the node η′ₐ is an end node. If the node η′ₐ is not an end node, no further action is taken in the transformation. If the node η′ₐ is an end node, an action 1132 is performed, in which \ddot{η}′ₐ is set as an end node. This completes the transformation 1116.

After the transformation 1116, [symbol] ′ₐ is equivalent to [symbol] ₐ, although the two DAGs may have different nodes and edge configurations.

The DAG subtraction 1118 comprises an action 1134 of determining whether the node η′_{b} is an end node. If the node η′_{b} is not an end node, no further action is taken within the subtraction 118. If the node η′_{b} is an end node, an action 1136 is performed, comprising making \ddot{η}′ₐ a non-ending node, which effectively removes the tokens of the edge (η_{b}, η′_{b}) from the tokens of the edge (ηₐ, \ddot{η}′ₐ).

After the subtraction 1118, the sub-method 1100(b) calls itself recursively for the nodes \ddot{η}′ₐ and η′_{b}. The recursion ends upon reaching the base case where neither node of a pair of nodes has outgoing edges.

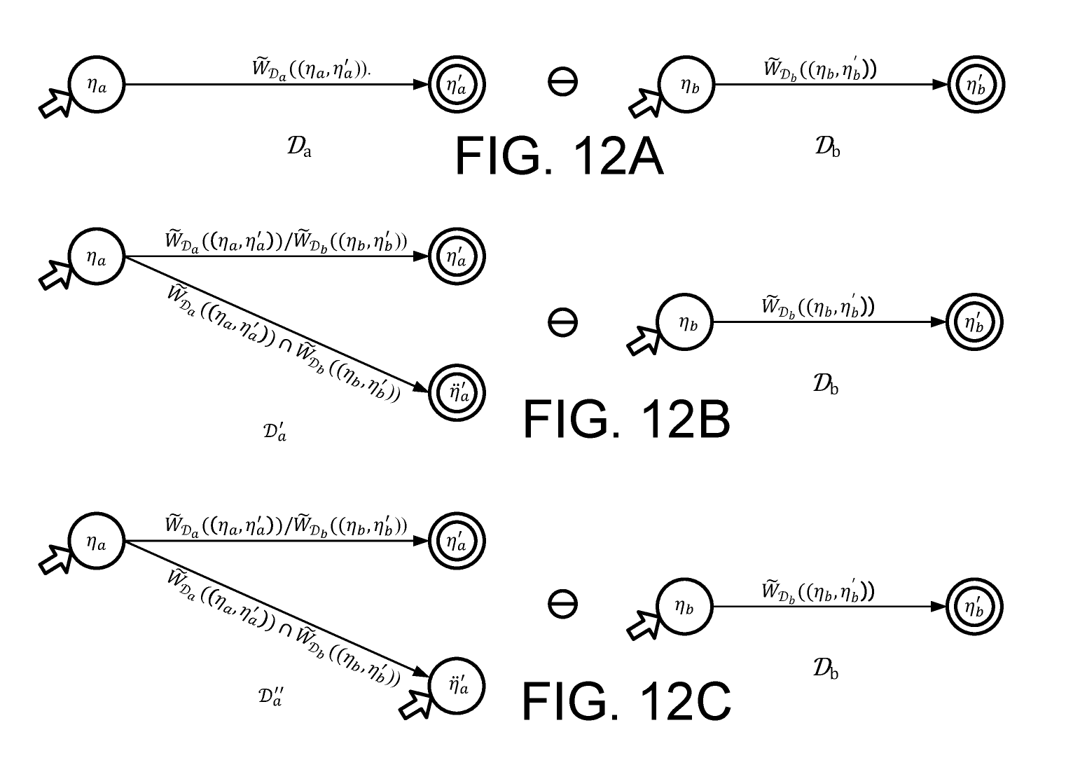

FIGS. 12A through 12B show an example of how two DAGs [symbol] ₐ and [symbol] _{b} are affected by the sub-method 1100(b) with respect to a pair of nodes ηₐ and η_{b}, and corresponding edges (ηₐ, η′ₐ) and (η_{b}, η′_{b}) that extend from node ηₐ to node η′ₐ and from node η_{b} to node η′_{b}, respectively.

FIG. 12A shows the original assignment of tokens. The edge (ηₐ, η′ₐ) has tokens [symbol] ((ηₐ, η′ₐ)). The edge (η_{b}, η′_{b}) has tokens [symbol] ((η_{b}, η′_{b})).

FIG. 12B shows how z□ₐ has been transformed into [symbol] ′ₐ. The node \ddot{η}′ₐ has been added, and the edge (ηₐ, \ddot{η}′ₐ) has been added. The tokens [symbol] (ηₐ, η′ₐ)) that were originally assigned to the edge (ηₐ, η′ₐ) have been partitioned and reassigned: the tokens [symbol] ((ηₐ, η′ₐ)/\tilde{W} [symbol] _{_{b}}((η_{b}, η′_{b})) are assigned to the edge (ηₐ, η′ₐ); and the tokens [symbol] ((ηₐ, η′ₐ))∩\tilde{W} [symbol] _{_{b}} ((η_{b}, η′_{b}))are assigned to the edge (ηₐ, \ddot{η}′ₐ).

FIG. 12C shows the resulting DAG [symbol] ″ₐ that results from the subtraction. In this example η′_{b} is an end node. Accordingly, the node \ddot{η}′ₐ is made into a non-ending node. Thus, the token sequences represented by [symbol] _{b} are no longer represented by [symbol] ″ₐ. However, other token sequences that originally traversed the edge (ηₐ, η′ₐ) are still represented by [symbol] ″ₐ.

### Determining Disjunctive Expressions

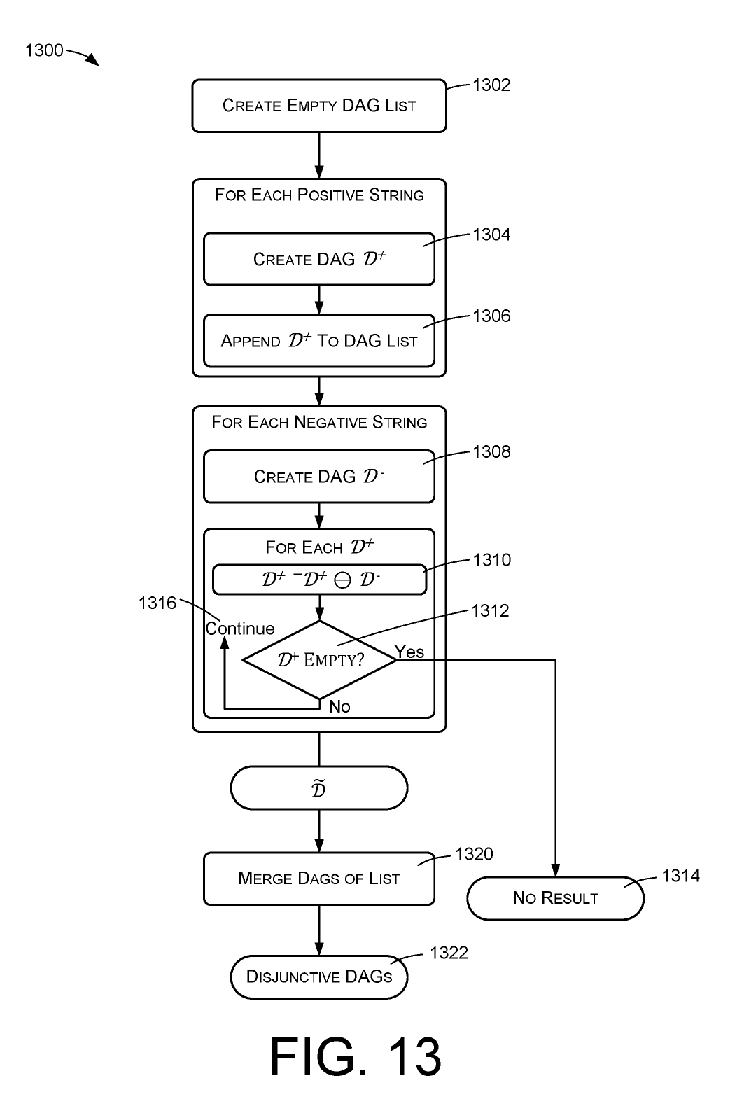

FIG. 13 illustrates another example method 1300, which in this case constructs a set or list of DAGs [symbol] , within which each DAG [symbol] is consistent with one or more positive example strings \tilde{S}⁺ and inconsistent with all negative example strings \tilde{S}⁻. Each DAG [symbol] of [symbol] represents an alternative set of token sequences.

An action 1302 comprises creating an empty DAG list [symbol] . Actions 1304 and 1306 are then performed for every positive example S⁺. The action 1304 comprises creating a DAG [symbol] ⁺ from the positive example string S⁺. The action 1306 comprises adding or appending the newly created DAG [symbol] ⁺ to the DAG list [symbol] .

Actions 1308, 1310, and 1312 are performed for every negative example S⁻. The action 1308 comprises learning a DAG [symbol] ⁻ from the negative example string S⁻. Actions 1310 and 1412 are then performed for every DAG [symbol] ⁺ of the DAG list [symbol] .

The action 1310 comprises subtracting the token sequences represented by [symbol] ⁻ from those in [symbol] ⁺, as indicated by the operator ⊖. The action 1312 comprises determining whether the resulting [symbol] ⁺ is empty. If so, the action 1314 is performed, which comprises returning an empty set or otherwise indicating that a disjunctive expression does not exist that is consistent with all of the positive and negative input strings. Otherwise, iteration of the actions 1310 and 1312 continues as indicated by the label 1316.

After iterating over every negative example string, producing the DAG list [symbol] as indicated by the label 1318, an action 1320 is performed, comprising merging the DAGs of the list [symbol] into partitions such that the intersection of DAGs in any partition is non-empty, in order to reduce the number of disjunctions in the final expression. An action 1320 comprises returning [symbol] as a disjunctive list of DAGs.

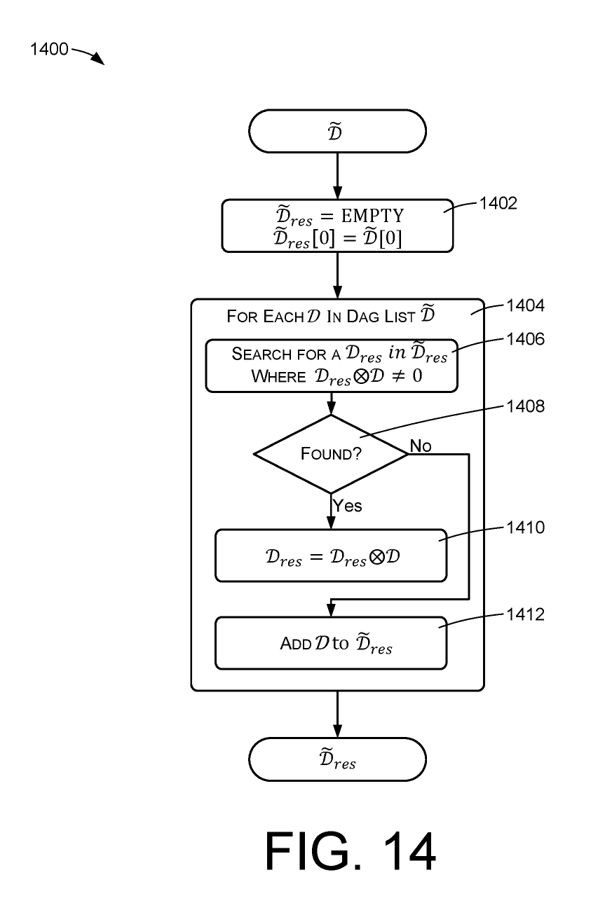

FIG. 14 illustrates an example technique for performing the action 1316 of merging DAGs of [symbol] . An action 1402 comprises creating an empty DAG list [symbol] ᵣₑₛ and creating a first element of [symbol] ᵣₑₛ that is equal to the first element of [symbol] .

A set of actions 1404 is performed for every D in the DAG list [symbol] . For a particular DAG [symbol] , an action 1406 comprising searching [symbol] ᵣₑₛ to find a DAG [symbol] ᵣₑₛ such that [symbol] ᵣₑₛ [symbol] [symbol] ≠0. If such a [symbol] ᵣₑₛ is found, as determined by the action 1508, an action 1410 is performed of updating the found [symbol] ᵣₑₛ by intersecting [symbol] with [symbol] ᵣₑₛ using the [symbol] operator, an implementation of which is described above. Otherwise, if no such [symbol] ᵣₑₛ is found in [symbol] ᵣₑₛ, an action 1412 is performed, comprising adding [symbol] to the DAG list [symbol] ᵣₑₛ.

After iterating over each [symbol] in the DAG list [symbol] in this manner, [symbol] ᵣₑₛ is returned as a list of DAGs corresponding to respective disjunctive expressions for a given predicate.

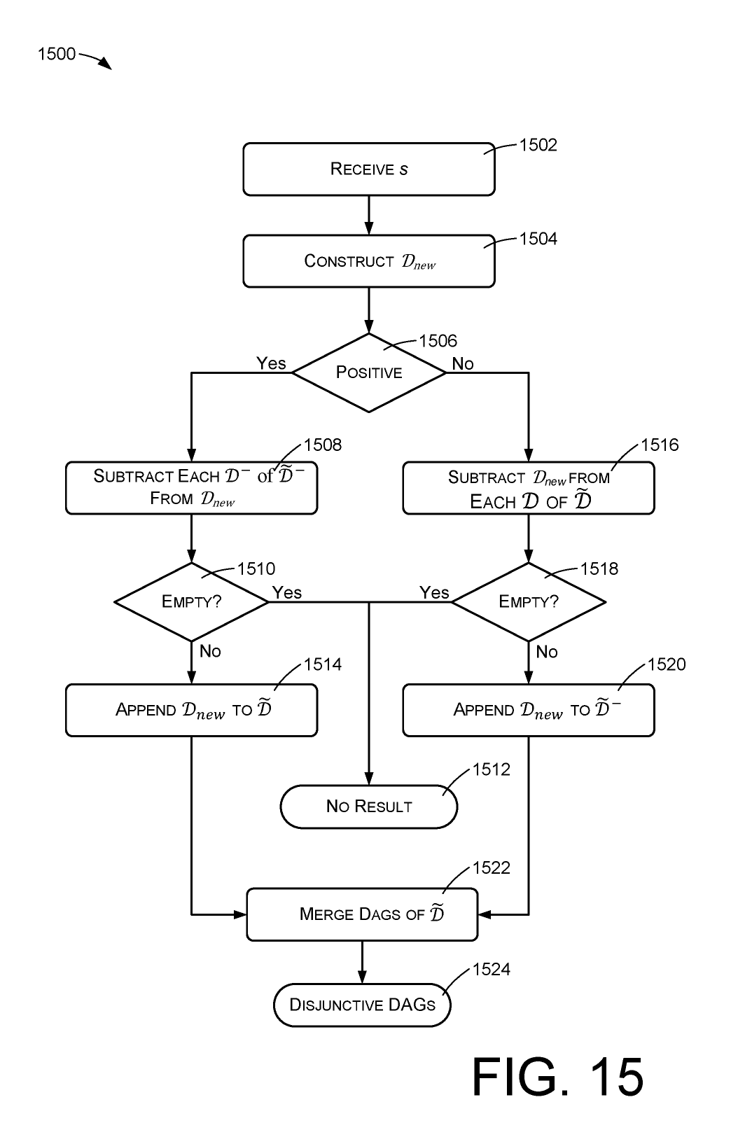

FIG. 15 illustrates example method 1500 that incrementally learns a disjunctive set or list of DAGs [symbol] , within which each DAG [symbol] is consistent with a one or more positive example strings and inconsistent with one or more negative example strings. The method 1500 is an alternative to the method 1300.

The method 1500 maintains the list [symbol] to store all the disjunctive expressions such that a predicate expression with any of those disjunctive expressions is consistent with all positive and negative strings in the past. The method 1500 also maintains a list of DAGs [symbol] ⁻ consisting of DAGs for each negative string example that has as yet been received.

An action 1502 comprises receiving a string s, which may be a positive example or a negative example. The method 1500 an assumes an existing list [symbol] and an existing list [symbol] ⁻, which have been constructed based on previous strings.

An action 1504 comprises constructing a DAG [symbol] _{new} for the string.

If the string s is a positive example, as determined by an action 1506, an action 1508 is performed of subtracting each [symbol] ⁻ of the negative DAG list [symbol] ⁻⁻ from the DAG [symbol] _{new} in accordance with the ⊖ operator. If the resulting DAG is empty, as determined by an action 1510, an action 1512 is performed of indicating that no disjunctive expression exists for the predicate. Otherwise, an action 1514 is performed of updating the current list of DAGs [symbol] by appending [symbol] _{new} to [symbol] .

If the current string is a negative example, as determined by the action 1604, an action 1516 is performed of subtracting [symbol] _{new} from every existing [symbol] of [symbol] in accordance with the ⊖ operator.

If any DAG [symbol] of [symbol] becomes empty, as determined by an action 1618, the action 1512 is performed of indicating that no disjunctive expression exists for the predicate. Otherwise, an action 1520 is performed of appending [symbol] _{new} to [symbol] ⁻.

After either action 1514 or the action 1520, an action 1522 is performed of merging the DAGs of [symbol] in accordance with the method 1400 of FIG. 14. An action 1524 comprises returning [symbol] as a disjunctive list of DAGs.

### Ranking

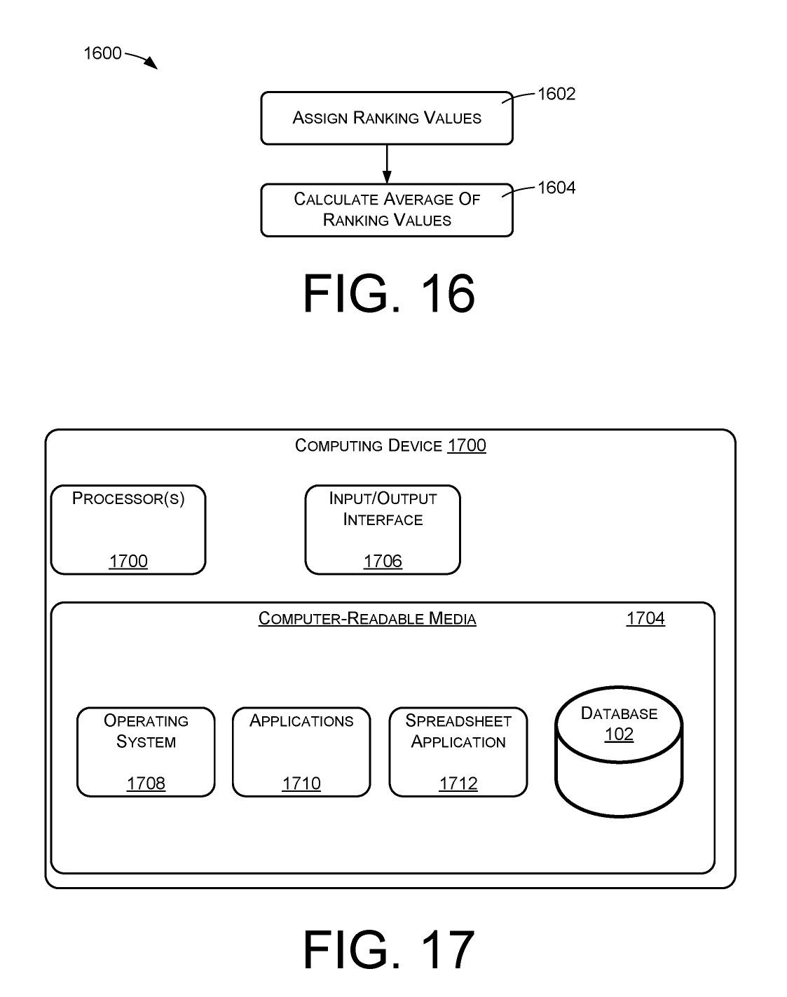

FIG. 16 illustrates an example method of ranking individual token sequences, such might be performed in various of the methods described above.

An action 1602 comprises assigning a ranking value to each available token of the set of available tokens defined by the DSL. This assignment is based at least in part on the generality of each token, with higher ranking values being assigned to tokens that are relatively more general and lower ranking values being assigned to tokens that are relatively more specific. For example, a general token that specifies a sequence of any type of character is quite general, and might be assigned a relatively high ranking value. On the other hand, a constant token that specifies a specific character is relatively less generally, and might be assigned a relatively low ranking value.

An action 1604 comprises determining an average ranking value for a particular token sequence, wherein the average ranking value is then used as a sequence ranking for the token sequence. The average ranking value is the sum of the ranking values that have been assigned to the tokens of the token sequence, divided by the number of tokens in the token sequence.

### Example Processing Environment

The methods and techniques described above may be implemented by an application running on a computer device such as a general-purpose computer, a tablet computer, a smailphone, a portable computer, etc. The method and techniques may also be implemented as an application in server-based and/or network-based environments by a server computer.

An application, for example, may comprise a spreadsheet application or other type of database, data viewing, or data management application. Furthermore, the data filtering described above may be provided as a service, such as a service provided by an Internet-based provider and/or another type of network-based service provider, and including services provided by network servers, websites, and other network entities.

Programs and/or instructions for executing the techniques and method described above may be stored on and executed from various types of computer-readable media, where the instructions are retrieved from the computer-readable media and executed by one or more processors processor.

FIG. 17 illustrates select components of an example computer device 1700 that may be used alone or in combination with other computers to implement the techniques described herein and to carry out the described methods. Among other components not shown, the example computer device 1700 comprises one or more processors 1702, computer-readable media 1704, and an input/output interface 1706.

The processor 1702 is configured to load and execute computer-executable instructions. The processor 1702 can comprise, for example, a CPU-type processing unit, a GPU-type processing unit, a field-programmable gate array (FPGA), another class of digital signal processor (DSP), or other hardware logic components that may, in some instances, be driven by a CPU. For example, and without limitation, illustrative types of hardware logic components that can be used include Application-Specific Integrated Circuits (ASICs), Application-Specific Standard Products (ASSPs), System-on-a-chip systems (SOCs), Complex Programmable Logic Devices (CPLDs), etc.

The input/output interface 1706 allows the computer 1700 to communicate with input/output devices such as user input devices including peripheral input devices (e.g., a keyboard, a mouse, a pen, a game controller, a voice input device, a touch input device, a gestural input device, and the like) and/or output devices including peripheral output devices (e.g., a display, a printer, audio speakers, a haptic output, and the like).

The computer-readable media 1704 stores executable instructions that are loadable and executable by processors 1702, wherein the instructions, when executed, implement the data filtering techniques described herein. Alternatively, or in addition, the functionally described herein can be performed, at least in part, by one or more hardware logic components such as accelerators. For example, and without limitation, illustrative types of hardware logic components that can be used include Field-programmable Gate Arrays (FPGAs), Application-specific Integrated Circuits (ASICs), Application-specific Standard Products (AS SPs), System-on-a-chip systems (SOCs), Complex Programmable Logic Devices (CPLDs), etc.

The computer-readable media 1704 can also store instructions executable by external processing units such as by an external CPU, an external GPU, and/or executable by an external accelerator, such as an FPGA type accelerator, a DSP type accelerator, or any other internal or external accelerator. In various examples at least one CPU, GPU, and/or accelerator is incorporated in the computer 1700, while in some examples one or more of a CPU, GPU, and/or accelerator is external to the computer 1700.

The executable instructions stored by the computer-readable media 1704 may include, for example, an operating system 1708, any number of applications 1710, the database 102, a spreadsheet application 1712 or other data-related application that may implement the filter engine 112 and filter evaluator 116.

The computer-readable media 1704 includes computer storage media and/or communication media. Computer storage media can include volatile memory, nonvolatile memory, and/or other persistent and/or auxiliary computer storage media, removable and non-removable computer storage media implemented in any method or technology for storage of information such as computer-readable instructions, data structures, program modules, or other data. The computer-readable media 1704 may include tangible and/or physical forms of media included in a device and/or hardware component that is part of a device or external to a device, including but not limited to random-access memory (RAM), static random-access memory (SRAM), dynamic random-access memory (DRAM), phase change memory (PRAM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer storage media, communication media embodies computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

The computer device 1700 may represent any of a variety of categories or classes of devices, such as client-type devices, server-type devices, desktop computer-type devices, mobile-type devices, special purpose-type devices, embedded-type devices, and/or wearable-type devices. Examples may include, for example, a tablet computer, a mobile phone/tablet hybrid, a personal data assistant, laptop computer, a personal computer, other mobile computers, wearable computers, implanted computing devices, desktop computers, terminals, work stations, or any other sort of computing device configured to implement the techniques described herein.

### Example Clauses

A: A method comprising: receiving identification of a positive string example from a list of strings; determining one or more corresponding first token sequences that correspond to the positive string example, the first token sequences defining respective character patterns that are consistent with the positive string example; receiving identification of a negative string example that is from the list of strings; determining one or more second token sequences that correspond to the negative string example, the second token sequences defining respective character patterns that are consistent with the negative string example; removing the one or more second token sequences from the first token sequences to create a first set of token sequences; selecting one or more token sequences of the first set; and producing a result set of strings from the list of strings, wherein each string of the result set is consistent with at least one of the selected one or more token sequences.

B: A method as Paragraph A recites, further comprising: displaying at least a portion of the list of strings to the user; accepting the identification of the positive string example from the user; accepting the identification of the negative string example from the user; and displaying the result set to the user.

C: A method as Paragraph A or Paragraph B recites, wherein the first and second token sequences comprise tokens that are from a set of available tokens, the method further comprising: assigning a ranking value to each available token of the set of available tokens; calculating a sequence ranking for each token sequence of the first set based at least in part on the ranking values of the tokens of the particular token sequence; wherein the selecting is based at least in part on the sequence rankings of the first set.

D: A method as Paragraphs A-C recite, further comprising: intersecting the one or more first token sequences corresponding to respective multiple positive string examples to produce a second set of token sequences, wherein the character pattern defined by any token sequence of the second set of token sequences is consistent with all of the multiple positive string examples.

E: A method as Paragraphs A-D recite, wherein the removing comprises removing the one or more second token sequences from the second set of token sequences.

F: A method as Paragraphs A-E recite, further comprising: receiving an identification of an additional positive string example; determining one or more additional first token sequences for the additional positive string example; and updating the first set of token sequences to include those token sequences that are common to the token sequences that are amongst the set of second token sequences.

G: A method as Paragraphs A-F recite, further comprising: receiving an identification of an additional negative string example; determining one or more additional second token sequences for the additional positive string example; and removing the one or more second token sequences from the first set of token sequences.

H: A method as Paragraphs A-G recite, further comprising: representing first token sequences that correspond to a first positive string example of the one or more positive string examples as a first directed acyclic graph (DAG); representing first token sequences that correspond to a second positive string example of the one or more positive string examples as a second DAG; each DAG having nodes that include start nodes and end nodes, and having directed edges between the nodes, wherein each directed edge has an associated set of one or more tokens; and determining an intersection of the first DAG and the second DAG, the intersection comprising: (a) the nodes of the first DAG and the second DAG, including the start nodes and end nodes of the first DAG and the second DAG, and (b) for a first directed edge of the first DAG that corresponds to a second directed edge of the second DAG, an intersection of the set of tokens associated with the first directed edge with the set of tokens associated with the second directed edge.

I: A method as Paragraphs A-H recite, further comprising: representing at least some of the first set of token sequences as a first directed acyclic graph (DAG); representing the one or more second token sequences as a second DAG; each DAG having nodes that include start nodes and end nodes, and having directed edges between the nodes, wherein each directed edge has an associated set of one or more tokens; wherein the removing comprises, with respect to a first and second nodes of a first DAG and third and fourth nodes of a second DAG, the first and second nodes corresponding to a first edge of the first DAG, the third and fourth nodes corresponding to a second edge of the second DAG, the first edge having a first associated set of tokens and the second edge having a second associated set of tokens: copying the second node to create a new node in the first DAG; if the second node is an end node, setting the new node as an end node; adding a new edge to the first DAG from the first node to the new node; calculating a third set of tokens comprising an intersection of the first set of tokens and the second set of tokens; associating the first set of tokens with the new edge; and removing the tokens of the third set from the first set of tokens; if the fourth node is an end node, setting the new node as a non-ending node.

J: A method as Paragraphs A-I recite, wherein each of the first and second token sequences is consistent with strings that (a) start with, (b) end with, (c) match, or (d) contain a corresponding character pattern.

K: One or more computer-readable media storing computer-executable instructions that, when executed by one or more processors of a first computer, cause the one or more processors to perform actions comprising: receiving identification of one or more positive string examples that are from a list of strings; creating a list of positive directed acyclic graphs (DAGs) corresponding respectively to the positive string examples, each positive DAG representing one or more first token sequences that define respective character patterns that are consistent with the corresponding positive string example; receiving identification of one or more negative string examples that are from the list of strings; creating negative DAGs corresponding respectively to the negative string examples, each negative DAG representing one or more second token sequences that define respective character patterns that are consistent with the corresponding negative string example; a particular DAG having nodes that include one or more start nodes and one or more end nodes, and having one or more directed edges between the nodes, wherein each directed edge has an associated set of one or more tokens; and for each positive DAGs, subtracting each negative DAG from the positive DAG.

L: A method as Paragraph K recites, the actions further comprising: selecting a token expression from each of two or more of the positive DAGs; and providing the selected token expressions as disjunctive token expressions that are consistent with the positive input strings and inconsistent with the negative input strings.

M: A method as Paragraph K or Paragraph L recites, the actions further comprising: ranking the token expressions represented by the positive DAGs; and providing the highest ranked token expression represented by each of at least two of the positive DAGs as disjunctive token expressions that are consistent with the positive input strings and not consistent with the negative input strings.

N: A method as Paragraphs K-M recite, wherein the first token sequences comprise tokens that are among a set of available tokens, the method further comprising: assigning a ranking value to each available token of the set of available tokens; ranking each token sequence represented by a particular positive DAG based at least in part on the ranking values of the tokens of the token sequence; and selecting one of the token sequences represented by the particular positive DAG based at least in part on the ranking of the token sequences represented by the particular positive DAG.

O: A method as Paragraphs K-N recite, the actions further comprising: receiving an identification of an additional positive string example from the list of strings; creating an additional positive DAG corresponding to the additional positive string example; and subtracting each negative DAG from the additional positive DAG.

P: A method as Paragraphs K-O recite, the actions further comprising: receiving an identification of an additional negative string example from the list of strings; creating an additional negative DAG corresponding to the additional negative string example; subtracting the negative DAG from each positive DAG.

Q: A method as Paragraphs K-P recite, wherein the subtracting comprises, with respect to a first and second nodes of a first DAG and third and fourth nodes of a second DAG, the first and second nodes corresponding to a first edge of the first DAG, the third and fourth nodes corresponding to a second edge of the second DAG, the first edge having a first associated set of tokens and the second edge having a second associated set of tokens: copying the second node to create a new node in the first DAG; if the second node is an end node, setting the new node as an end node; adding a new edge to the first DAG from the first node to the new node; calculating a third set of tokens comprising an intersection of the first set of tokens and the second set of tokens; associating the first set of tokens with the new edge; removing the tokens of the third set from the first set of tokens; and if the fourth node is an end node, setting the new node as a non-ending node.

R: A method as Paragraphs K-Q recite, wherein each of the first and second token sequences are consistent with strings that (a) start with, (b) end with, (c) match, or (d) contain a corresponding character pattern.

S: A method, comprising: creating a first directed acyclic graph (DAG) to represent one or more first token sequences that define first respective character patterns; creating a second directed acyclic graph (DAG) to represent one or more first second token sequences that define second respective character patterns; removing the second token sequences from representation by the first DAG, the removing comprising, with respect to a first and second nodes of a first DAG and third and fourth nodes of a second DAG, the first and second nodes corresponding to a first edge of the first DAG, the third and fourth nodes corresponding to a second edge of the second DAG, the first edge having a first associated set of tokens and the second edge having a second associated set of tokens: copying the second node to create a new node in the first DAG; if the second node is an end node, setting the new node as an end node; adding a new edge to the first DAG from the first node to the new node; calculating a third set of tokens comprising an intersection of the first set of tokens and the second set of tokens; associating the first set of tokens with the new edge; removing the tokens of the third set from the first set of tokens; and if the fourth node is an end node, setting the new node as a non-ending node.

T: A method as Paragraph S recites, further comprising: receiving an indication of one or more positive string examples of a list of strings, wherein the positive string examples are to be included in a filtered result set; wherein the first DAG is created such that the character patterns defined by the one or more first token sequences are consistent with the one or more positive string examples; receiving an indication of one or more negative string examples of the list of strings, wherein the negative string examples are to be excluded from the filtered result set; wherein the second DAG is created such that the character patterns defined by the one or more second token sequences are consistent with the one or more negative string examples; filtering the list of strings in accordance with one or more token sequences represented by the first DAG to create the filtered result set.

### CONCLUSION

Although the techniques have been described in language specific to structural features and/or methodological acts, it is to be understood that the appended claims are not necessarily limited to the features or acts described. Rather, the features and acts are described as example implementations of such techniques.

The operations of the example methods are illustrated in individual blocks and summarized with reference to those blocks. The methods are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations. Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s), such as one or more internal or external CPUs or GPUs, and/or one or more pieces of hardware logic such as FPGAs, DSPs, or other types of accelerators.

All of the methods and processes described above may be embodied in, and fully automated via, software code modules executed by one or more general purpose computers or processors. The code modules may be stored in any type of computer-readable storage medium or other computer storage device. Some or all of the methods may alternatively be embodied in specialized computer hardware.

Conditional language such as, among others, “can,” “could,” “might” or “may,” unless specifically stated otherwise, are understood within the context to present that certain examples include, while other examples do not include, certain features, elements and/or steps. The use or non-use of such conditional language is not intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to mean that an item, term, etc. may be either X, Y, or Z, or a combination of any number of any of the elements X, Y, or Z.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art. It should be emphasized that many variations and modifications may be made to the above-described examples, the elements of which are to be understood as being among other acceptable examples. All such modifications and variations are intended to be included herein within the scope of this disclosure and protected by the following claims.

What is claimed is:

1. A method comprising:
receiving identification of a positive string example from a list of strings;
determining one or more corresponding first token sequences that correspond to the positive string example, the first token sequences defining respective character patterns that are consistent with the positive string example;
receiving identification of a negative string example that is from the list of strings;
determining one or more second token sequences that correspond to the negative string example, the second token sequences defining respective character patterns that are consistent with the negative string example;
removing the one or more second token sequences from the first token sequences to create a first set of token sequences;
selecting one or more token sequences of the first set; and
producing a result set of strings from the list of strings, wherein each string of the result set is consistent with at least one of the selected one or more token sequences.

2. The method of claim 1, further comprising:
displaying at least a portion of the list of strings to the user;
accepting the identification of the positive string example from the user;
accepting the identification of the negative string example from the user; and
displaying the result set to the user.

3. The method of claim 1, wherein the first and second token sequences comprise tokens that are from a set of available tokens, the method further comprising:
assigning a ranking value to each available token of the set of available tokens;
calculating a sequence ranking for each token sequence of the first set based at least in part on the ranking values of the tokens of the particular token sequence; and
wherein the selecting is based at least in part on the sequence rankings of the first set.

4. The method of claim 1, further comprising: intersecting the one or more first token sequences corresponding to respective multiple positive string examples to produce a second set of token sequences, wherein the character pattern defined by any token sequence of the second set of token sequences is consistent with all of the multiple positive string examples.

5. The method of claim 1, wherein the removing comprises removing the one or more second token sequences from the second set of token sequences.

6. The method of claim 1, further comprising:
receiving an identification of an additional positive string example;
determining one or more additional first token sequences for the additional positive string example; and
updating the first set of token sequences to include those token sequences that are common to the token sequences that are amongst the set of second token sequences.

7. The method of claim 1, further comprising:
receiving an identification of an additional negative string example;
determining one or more additional second token sequences for the additional positive string example; and
removing the one or more second token sequences from the first set of token sequences.

8. The method of claim 1, further comprising:
representing first token sequences that correspond to a first positive string example of the one or more positive string examples as a first directed acyclic graph (DAG);
representing first token sequences that correspond to a second positive string example of the one or more positive string examples as a second DAG;
each DAG having nodes that include start nodes and end nodes, and having directed edges between the nodes, wherein each directed edge has an associated set of one or more tokens; and
determining an intersection of the first DAG and the second DAG, the intersection comprising: (a) the nodes of the first DAG and the second DAG, including the start nodes and end nodes of the first DAG and the second DAG, and (b) for a first directed edge of the first DAG that corresponds to a second directed edge of the second DAG, an intersection of the set of tokens associated with the first directed edge with the set of tokens associated with the second directed edge.

9. The method of claim 1, further comprising:
representing at least some of the first set of token sequences as a first directed acyclic graph (DAG);
representing the one or more second token sequences as a second DAG;
each DAG having nodes that include start nodes and end nodes, and having directed edges between the nodes, wherein each directed edge has an associated set of one or more tokens;
wherein the removing comprises, with respect to a first and second nodes of a first DAG and third and fourth nodes of a second DAG, the first and second nodes corresponding to a first edge of the first DAG, the third and fourth nodes corresponding to a second edge of the second DAG, the first edge having a first associated set of tokens and the second edge having a second associated set of tokens:
copying the second node to create a new node in the first DAG;
if the second node is an end node, setting the new node as an end node;
adding a new edge to the first DAG from the first node to the new node;
calculating a third set of tokens comprising an intersection of the first set of tokens and the second set of tokens;
associating the first set of tokens with the new edge; and
removing the tokens of the third set from the first set of tokens; and
if the fourth node is an end node, setting the new node as a non-ending node.

10. The method of claim 1, wherein each of the first and second token sequences is consistent with strings that (a) start with, (b) end with, (c) match, or (d) contain a corresponding character pattern.

11. One or more computer-readable media storing computer-executable instructions that, when executed by one or more processors of a first computer, cause the one or more processors to perform actions comprising:
receiving identification of one or more positive string examples that are from a list of strings;
creating a list of positive directed acyclic graphs (DAGs) corresponding respectively to the positive string examples, each positive DAG representing one or more first token sequences that define respective character patterns that are consistent with the corresponding positive string example;
receiving identification of one or more negative string examples that are from the list of strings;
creating negative DAGs corresponding respectively to the negative string examples, each negative DAG representing one or more second token sequences that define respective character patterns that are consistent with the corresponding negative string example;
a particular DAG having nodes that include one or more start nodes and one or more end nodes, and having one or more directed edges between the nodes, wherein each directed edge has an associated set of one or more tokens; and
for each positive DAGs, subtracting each negative DAG from the positive DAG.

12. The one or more computer-readable media of claim 11, the actions further comprising:
selecting a token expression from each of two or more of the positive DAGs; and
providing the selected token expressions as disjunctive token expressions that are consistent with the positive input strings and inconsistent with the negative input strings.

13. The one or more computer-readable media of claim 11, the actions further comprising:
ranking the token expressions represented by the positive DAGs; and
providing the highest ranked token expression represented by each of at least two of the positive DAGs as disjunctive token expressions that are consistent with the positive input strings and not consistent with the negative input strings.

14. The one or more computer-readable media of claim 11, wherein the first token sequences comprise tokens that are among a set of available tokens, the method further comprising:
assigning a ranking value to each available token of the set of available tokens;
ranking each token sequence represented by a particular positive DAG based at least in part on the ranking values of the tokens of the token sequence; and
selecting one of the token sequences represented by the particular positive DAG based at least in part on the ranking of the token sequences represented by the particular positive DAG.

15. The one or more computer-readable media of claim 11, the actions further comprising:
receiving an identification of an additional positive string example from the list of strings;
creating an additional positive DAG corresponding to the additional positive string example; and
subtracting each negative DAG from the additional positive DAG.

16. The one or more computer-readable media of claim 11, the actions further comprising:
receiving an identification of an additional negative string example from the list of strings;
creating an additional negative DAG corresponding to the additional negative string example; and
subtracting the negative DAG from each positive DAG.

17. The one or more computer-readable media of claim 11, wherein the subtracting comprises, with respect to a first and second nodes of a first DAG and third and fourth nodes of a second DAG, the first and second nodes corresponding to a first edge of the first DAG, the third and fourth nodes corresponding to a second edge of the second DAG, the first edge having a first associated set of tokens and the second edge having a second associated set of tokens:
copying the second node to create a new node in the first DAG;
if the second node is an end node, setting the new node as an end node;
adding a new edge to the first DAG from the first node to the new node;
calculating a third set of tokens comprising an intersection of the first set of tokens and the second set of tokens;
associating the first set of tokens with the new edge;
removing the tokens of the third set from the first set of tokens; and
if the fourth node is an end node, setting the new node as a non-ending node.

18. The one or more computer-readable media of claim 11, wherein each of the first and second token sequences are consistent with strings that (a) start with, (b) end with, (c) match, or (d) contain a corresponding character pattern.

19. A method, comprising:
creating a first directed acyclic graph (DAG) to represent one or more first token sequences that define first respective character patterns;
creating a second directed acyclic graph (DAG) to represent one or more first second token sequences that define second respective character patterns;
removing the second token sequences from representation by the first DAG, the removing comprising, with respect to a first and second nodes of a first DAG and third and fourth nodes of a second DAG, the first and second nodes corresponding to a first edge of the first DAG, the third and fourth nodes corresponding to a second edge of the second DAG, the first edge having a first associated set of tokens and the second edge having a second associated set of tokens:
copying the second node to create a new node in the first DAG;
if the second node is an end node, setting the new node as an end node;
adding a new edge to the first DAG from the first node to the new node;
calculating a third set of tokens comprising an intersection of the first set of tokens and the second set of tokens;
associating the first set of tokens with the new edge;
removing the tokens of the third set from the first set of tokens; and
if the fourth node is an end node, setting the new node as a non-ending node.

20. The method of claim 19, further comprising:
receiving an indication of one or more positive string examples of a list of strings, wherein the positive string examples are to be included in a filtered result set;
wherein the first DAG is created such that the character patterns defined by the one or more first token sequences are consistent with the one or more positive string examples;
receiving an indication of one or more negative string examples of the list of strings, wherein the negative string examples are to be excluded from the filtered result set;
wherein the second DAG is created such that the character patterns defined by the one or more second token sequences are consistent with the one or more negative string examples; and
filtering the list of strings in accordance with one or more token sequences represented by the first DAG to create the filtered result set.
